(19) United States
(12) Patent Application Publication
(10) Pub. No.: US 2026/0332391 A1
(43) Pub. Date: Oct. 22, 2026

(54) METHOD FOR PROVIDING OUT OF BAND AUTHENTICATION OVER MOBILE NETWORK AND COMPUTER PROGRAM PRODUCT IMPLEMENTING THE SAME

(71) Applicant: Taisys Technologies Co., Ltd., Taipei (TW)

(72) Inventor: CHUN HSIN HO, Taipei (TW)

(21) Appl. No.: 19/184,205

(22) Filed: Apr. 21, 2025

(51) Int. Cl. H04L 9/08; H04L 9/32

(52) U.S. Cl. CPC H04L 9/0825; H04L 9/3226; H04L 9/3247

(57) ABSTRACT

A method of providing out of band authentication over mobile network comprises: a) generating a pair of a public key and a private key by an identity verification unit in a mobile communication device and sending the public key with an identity number to a first server through a first mobile communication channel by the mobile communication device; b) receiving a message containing a random secret and operational information from a second server via the first server through a second mobile communication channel by the mobile communication device, wherein the message is encrypted with the public key provided by the first server provided that the identity number is sent along with the message by the second server; c) decrypting the message with the private key by the identity verification unit; and d) displaying the operational information and the random secret by the mobile communication device for use by a user.

### FIELD OF THE INVENTION

The present invention relates to an identity verification technology. More particularly, the present invention relates to a method for providing out of band authentication over mobile network and computer program product implementing the method.

### BACKGROUND OF THE INVENTION

One-time password (OTP) is a security technology used in identity authentication. It is a type of two-factor authentication (2FA) and is currently the most widely used short message service (SMS) out-of-band authentication, leveraging the existing convenience of mobile infrastructure. The purpose of OTP is to prevent password theft and replay attacks. The operating characteristics of OTP are that each time a user logs in or conducts a transaction on a major communication channel, the system will generate a different password, which is only valid for a short period of time and expires after being used once. It requires another independent communication channel for auxiliary verification. The two communication channels involved are usually the wireless network that the user's Internet connection connects to and the wireless network that the phone runs on.

As the most widespread identity authentication method today, OTP has many usage scenarios. Whether it is identity login authentication, online banking and payment, e-commerce platform or enterprise system login, social media and email access, or even the operation of cryptocurrency exchanges, OTP can be applied to use. Although OTP can effectively improve security, it is not completely foolproof and there are still some concerns. OTP has the following security concerns: SIM swap, SS7 technical flaws, abuse of SMS phone verification service for creating fake accounts and web identity theft. Meanwhile, SMS OTP has provided bad user experience clicking to enter, testing memory, and faces malicious attacks from social engineering. Towards the end of July 2016, the National Institute of Standards and Technology (NIST) started the process of deprecating the use of SMS-based out-of-band authentication. This became clear in the issue of the DRAFT NIST Special Publication 800-63B, Digital Authentication Guideline.

In order to solve the security concerns of traditional SMS OTP in operation, enhance user experience, and provide support to multiple application scenarios, the present invention is proposed.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to solve the problems mentioned above, a method of providing out of band authentication over mobile network. The method includes steps of: a) generating a pair of a public key and a private key by an identity verification unit in a mobile communication device and creating a Personal Identification Number (PIN) code by the identity verification unit; b) sending the public key with an identity number to a first server through a first mobile communication channel by the mobile communication device; c) receiving a message containing a random secret and an operational information from a second server via the first server through a second mobile communication channel by the mobile communication device, wherein the message is encrypted with the public key provided by the first server provided that the identity number is sent along with the message by the second server; d) decrypting the message with the private key by the identity verification unit; e) displaying the operational information by the mobile communication device for requesting a verification code for the operational information from a user; f) receiving the verification code by the mobile communication device; g) verifying if the verification code is the same as the PIN code and signing the random secret with the private key by the identity verification unit when verified; and h) sending the signed random secret to the first server by the mobile communication device through the first mobile communication channel.

Preferably, the identity verification unit may be a Subscriber Identity Module (SIM) card in the mobile communication device, a thin film SIM attached to a SIM card in the mobile communication device, or a Central Processing Unit (CPU) of the mobile communication device running an embedded-SIM (eSIM) or a program.

According to the present invention, the first mobile communication channel may be an Over-The-Air (OTA) technology communication channel, implemented by Bearer Independent Protocol (BIP).

According to the present invention, the second mobile communication channel may be an OTA technology communication channel, implemented by Short Message Service-Point to Point (SMS-PP) technology.

According to the present invention, the first mobile communication channel and the second mobile communication channel are both Open Mobile Alliance (OMA) or Google Carrier Services (GCS) channel when the identity verification unit is a CPU of the mobile communication device running a program. The first mobile communication channel and the second mobile communication channel are accessed by the mobile communication device through a non-wi-fi access point.

Preferably, the random secret may be a randomly generated token, a time-based token, a counter-based token, a transaction identifier, or a hashed transaction identifier.

Preferably, the identity number may be International Mobile Subscriber Identity (IMSI) attached to a cellular mobile network, Mobile Subscriber ISDN Number (MSISDN) attached to a cellular mobile network or wallet address attached to a blockchain network.

Preferably, the operational information may be authenticating information or transactional information.

Another method of providing out of band authentication over mobile network is also disclosed in the present invention. The method includes the steps of: a) generating a pair of a public key and a private key by an identity verification unit in a mobile communication device and sending the public key with an identity number to a first server through a first mobile communication channel by the mobile communication device; b) receiving a message containing a random secret and an operational information from a second server via the first server through a second mobile communication channel by the mobile communication device, wherein the message is encrypted with the public key provided by the first server provided that the identity number is sent along with the message by the second server; c) decrypting the message with the private key by the identity verification unit; and d) displaying the operational information and the random secret by the mobile communication device for use by a user.

Preferably, the identity verification unit may be a SIM card in the mobile communication device, a thin film SIM attached to a SIM card in the mobile communication device, or a CPU of the mobile communication device running an eSIM or a program.

According to the present invention, the first mobile communication channel is an OTA technology communication channel, implemented by BIP.

According to the present invention, the second mobile communication channel is an OTA technology communication channel, implemented by SMS-PP technology.

According to the present invention, the first mobile communication channel and the second mobile communication channel are both OMA or GCS channel when the identity verification unit is a CPU of the mobile communication device running a program. The first mobile communication channel and the second mobile communication channel are accessed by the mobile communication device through a non-wi-fi access point.

Preferably, the random secret may be a randomly generated token, a time-based token, a counter-based token, a transaction identifier, or a hashed transaction identifier.

Preferably, the identity number may be IMSI attached to a cellular mobile network, MSISDN attached to a cellular mobile network or wallet address attached to a blockchain network.

Preferably, the operational information may be authenticating information or transactional information.

A computer program product is further disclosed in the present invention. The computer program product, when loaded into an identity verification unit of a mobile communication device and executed, performing the method as described above.

The security concerns of traditional OTP in operation can be solved by the present invention since SIM swap, SS7 technical flaws, SMS phone verification service and web identity theft will not happen in the data structure disclosed in the embodiment. User experience can be enhanced since only one PIN code should be memorized and users don't have to key in one time number every time for out of band authentication. As shown in the embodiments below, multiple application scenarios can be possible. The problems mentioned above can be solved.

### BRIEF DESCRIPTION OF THE DRAWINGS

FIG. 1 is a flow chart of a method for providing out of band authentication over mobile network according to a first embodiment of the present invention.

FIG. 2 is a schematic diagram of an application scenario of the first embodiment.

FIG. 3 is a flow chart of another method for providing out of band authentication over mobile network according to a second embodiment of the present invention.

FIG. 4 is a schematic diagram of an application scenario of the second embodiment.

### DETAILED DESCRIPTION OF THE PREFERRED EMBODIMENTS

The present invention will now be described more specifically with reference to the following embodiments.

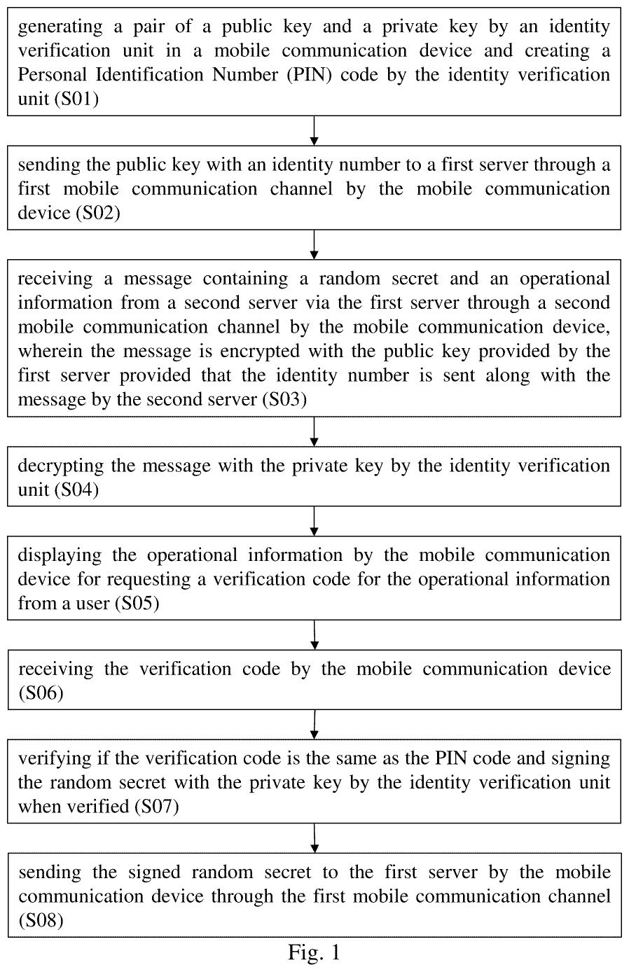

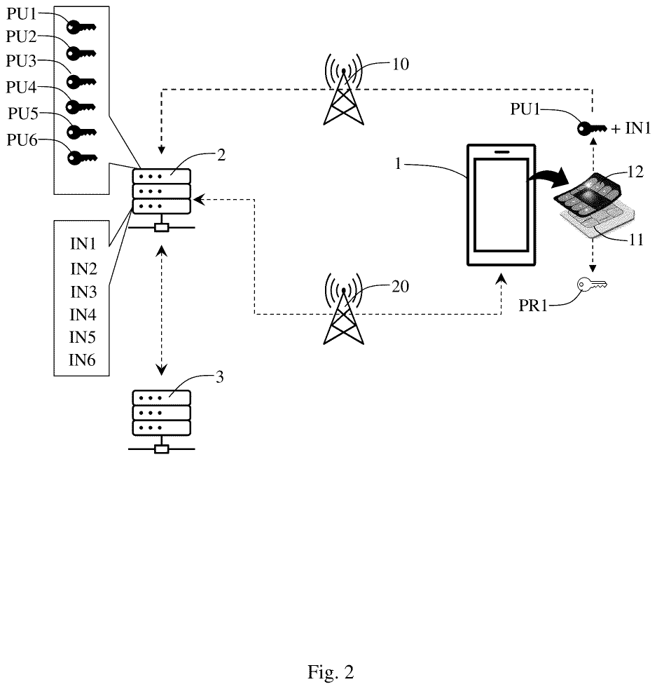

See FIG. 1 and FIG. 2. FIG. 1 is a flow chart of a method for providing out of band authentication over mobile network (hereinafter referred to as the method) according to a first embodiment of the present invention. FIG. 2 is a schematic diagram of an application scenario of the first embodiment. In this embodiment, a user of a cellular mobile 1 conducts a transaction, for example, purchasing an NFT, on a platform provided by a second server 3 over Internet. The second server 3 needs to identify the user and performs an out of band authentication over a mobile network. According to the present invention, the method is implemented by a computer program product. The computer program product will be described in following texts.

A first step of the method is generating a pair of a public key and a private key by an identity verification unit in a mobile communication device and creating a Personal Identification Number (PIN) code by the identity verification unit (S01). The mobile communication device refers to the cellular mobile. In general, it may be other devices which can provide video and audio communications with a Subscriber Identity Module (SIM), such as a tablet. The identity verification unit is an electronic component installed or equipped in the mobile communication device to provide the functions of the SIM or be the SIM. Therefore, a specific example of the identity verification unit may be, but not limited to a SIM card in the mobile communication device, a thin film SIM, such as a laminated card assembly disclosed in US20080076474A1, attached to a SIM card in the mobile communication device or a Central Processing Unit (CPU) of the mobile communication device running an embedded-SIM (eSIM) or a program. Here, the eSIM is embedded directly into the mobile communication device as software installed onto an eUICC chip which is the CPU mentioned above. The computer program product, when loaded into the identity verification unit of the mobile communication device and executed, can perform the method. The computer program product may be one run by the SIM card, the thin film SIM or the CPU. Thus, the computer program product is the program run by the CPU. In this embodiment, the identity verification unit is a thin film SIM 12 attached to a SIM card 11 in the cellular mobile 1.

The identity verification unit, the thin film SIM 12, is installed with the computer program product, so that the computer program product can be run by the thin film SIM 12 to generate a public key PU1 and a private key PR1. The generation method is not restricted by the present invention. For example, the generation method may be Rivest-Shamir-Adleman (RSA) algorithm, digital signature algorithm or elliptic curve cryptography algorithm. The PIN code is created by the identity verification unit. More precisely, the PIN code is input to the identity verification unit via the mobile communication device and the identity verification unit create the same for use in next steps of the method. The PIN code may be a few numbers, letters or their combination.

A second step of the method is sending the public key PU1 with an identity number IN1 to a first server 2 through a first mobile communication channel 10 by the mobile communication device, the cellular mobile 1 (S02). The identity number IN1 is a unique number which identity the identity verification unit. For example, the identity number IN1 may be International Mobile Subscriber Identity (IMSI) attached to a cellular mobile network, Mobile Subscriber ISDN Number (MSISDN) attached to a cellular mobile network, or even wallet address attached to a blockchain network. The first server 2 is used to keep and provide public keys, e.g., PU1 to PU6, and corresponding identity numbers, e.g., IN1 to IN6, for use of out of band authentication for different mobile communication devices. According to the present invention, the first mobile communication channel 10 is an Over-The-Air (OTA) technology communication channel. Specifically, the OTA is implemented by Bearer Independent Protocol (BIP). The first mobile communication channel 10 may be another channel under certain conditions. When the identity verification unit is a CPU of the mobile communication device running a program, the first mobile communication channel 10 can be Open Mobile Alliance (OMA) or Google Carrier Services (GCS) channel which the CPU supports. It should be noted that the first mobile communication channel 10 should be accessed by the mobile communication device through a non-wi-fi access point. Namely, the mobile communication channel 10 should be accessed directly through the communication base station.

A third step of the method is receiving a message containing a random secret and an operational information from the second server 3 via the first server 2 through a second mobile communication channel 20 by the mobile communication device (cellular mobile 1), wherein the message is encrypted with the public key provided by the first server 2 provided that the identity number is sent along with the message by the second server 3 (S03). There might be a number of mobile communication devices in contact with the second server 3. As mentioned above, the second server 3 operates the platform and performs the out of band authentication, it has to tell the second server 3 which mobile communication device the out of band authentication is conducted. The identity number points out the one. Meanwhile, the second server 3 also sends out the message with the identity number. The random secret provides feedback from the mobile communication device after the out of band authentication and the operational information informs the user of the cellular mobile 1 which operation the out of band authentication is requested. In practice, the random secret may a randomly generated token, a time-based token (expired when a set time is up), a counter-based token (expired when a number of times being called), a transaction identifier (for a specified transaction), or a hashed transaction identifier from the second server 3. The operational information may be authenticating information for informing the user of the details of the out of band authentication, or transactional information for informing the user of a transaction. When the message is provided to the first server 2, it is plain text without being encrypted. Before the message is sent out from the first server 2, it is encrypted with the public key PU1 provided by the first server 2.

The cellular mobile 1 receives the encrypted message through the second mobile communication channel 20 rather than the first mobile communication channel 10. According to the present invention, the second mobile communication channel 20 is an OTA technology communication channel, implemented by Short Message Service-Point to Point (SMS-PP) technology. When the identity verification unit is a CPU of the mobile communication device running a program, the second mobile communication channel 20 can be OMA or GCS channel depending on the CPU. However, under this condition, the first mobile communication channel 10 and the second mobile communication channel 20 should be both OMA or GCS channel. Similarly, the second mobile communication channel 20 should be accessed by the cellular mobile 1 through a non-wi-fi access point.

A fourth step of the method is decrypting the message with the private key PRI by the identity verification unit (S04). Namely, the thin film SIM 12 uses the private key PR1 to decrypt the message to have the random secret and the operational information.

A fifth step of the method is displaying the operational information by the mobile communication device (cellular mobile 1) for requesting a verification code for the operational information from a user (S05). According to the present invention, the operational information contains an illustration to request the user of the cellular mobile 1 to input the verification code. The verification code is used to check if it is the same as the PIN code.

A sixth step of the method is receiving the verification code by the mobile communication device (cellular mobile 1) (S06). A seventh step of the method is verifying if the verification code is the same as the PIN code and signing the random secret with the private key PRI by the identity verification unit (thin film SIM 12) when verified (S07). This step is to sign the random secret as a digital signature for further use when the verification code input by the user is the same as the PIN code he set. This is similar to the conventional out of band authentication that requires the user to input a PIN code which has been informed to him through SMS to confirm that the same person handles the PIN code. The method asks the user to input the same PIN code he set instead to identify.

The last step of the method is sending the signed random secret to the first server 2 by the mobile communication device (cellular mobile 1) through the first mobile communication channel 10 (S08). The signed random secret is used as a proof of verification and will be passed to the second server 3 from the first server 2 for further use.

According to the present invention, the verification is not required to be carried out by the identity verification unit, and the result of the verification doesn't have to be sent back to the first/second server. A second embodiment below illustrates another method of providing out of band authentication over a mobile network.

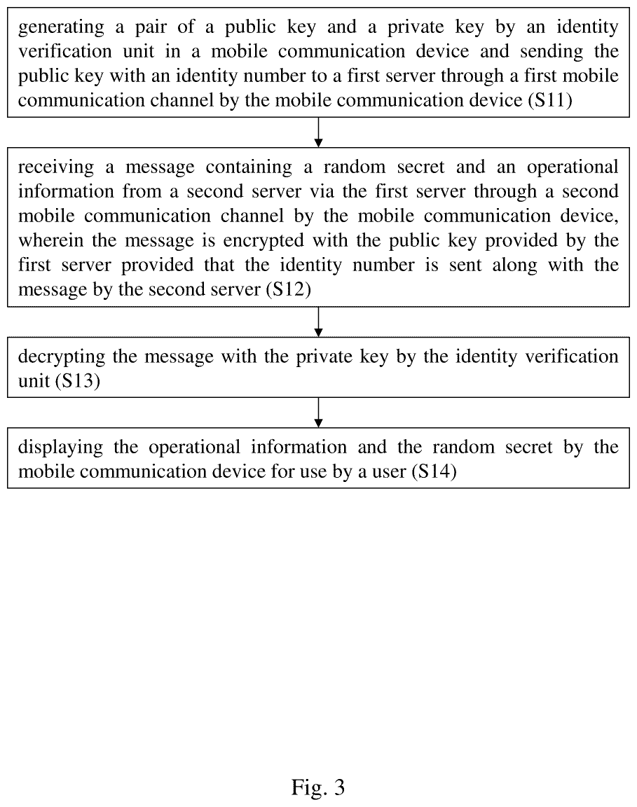

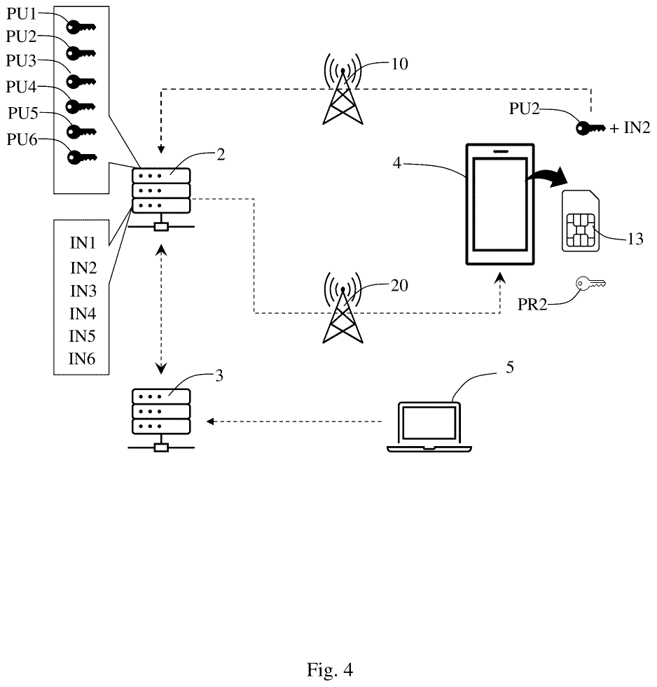

See FIG. 3 and FIG. 4. FIG. 3 is a flow chart of another method for providing out of band authentication over a mobile network (hereinafter referred to as the method) according to the second embodiment of the present invention. FIG. 4 is a schematic diagram of an application scenario of the second embodiment. In this embodiment, a user of a tablet 4 carries out a transaction on the platform provided by the second server 3 over Internet. The second server 3 needs to identify the user and performs an out of band authentication over a mobile network. The method in the second embodiment is also implemented by a computer program product. The computer program product is defined as that in the first embodiment and not repeated. In order to reduce the description, the same symbol in FIG. 4 and FIG. 2 refers to the same item and have similar functions.

A first step of the method is generating a pair of a public key PU2 and a private key PR2 by an identity verification unit in a mobile communication device and sending the public key PU2 with an identity number to a first server 2 through a first mobile communication channel 10 by the mobile communication device (S11). The identity verification unit may be a SIM card in the mobile communication device, a thin film SIM attached to a SIM card in the mobile communication device, or a CPU of the mobile communication device running an eSIM or a program. In this embodiment, the mobile communication device is the tablet 4 and the identity verification unit is a SIM card 13 in the tablet 4. The generation method to generate the pair of the public key PU2 and the private key PR2 is also not restricted. The identity number is the same as that in the first embodiment, IMSI attached to a cellular mobile network, MSISDN attached to a cellular mobile network or wallet address attached to a blockchain network. The first mobile communication channel 10 is an OTA technology communication channel, implemented by BIP.

A second step of the method is receiving a message containing a random secret and an operational information from a second server 3 via the first server 2 through a second mobile communication channel 20 by the mobile communication device (tablet 4), wherein the message is encrypted with the public key PU2 provided by the first server 2 provided that the identity number is sent along with the message by the second server 3 (S12). The second mobile communication channel 20 is also the OTA technology communication channel, implemented by SMS-PP technology. It should be noticed that the first mobile communication channel 10 and the second mobile communication channel 20 should be both OMA or GCS channel when the identity verification unit is a CPU of the tablet 4 running a program. The first mobile communication channel 10 and the second mobile communication channel 20 are also accessed by the tablet 4 through a non-wi-fi access point as described in the first embodiment. The random secret may be a randomly generated token, a time-based token, a counter-based token, a transaction identifier, or a hashed transaction identifier. The operational information may be authenticating information or transactional information.

A third step of the method is decrypting the message with the private key PR2 by the identity verification unit (SIM card 13) (S13). This step is the same as the step S04 in the first embodiment.

The last step of the method is displaying the operational information and the random secret by the mobile communication device (tablet 4) for use by a user (S14). In addition to the operational information, the random secret also needs to be displayed to the user and used by the user later for further verification. For example, the random secret is input to a laptop computer 5 to a shopping website run by the second server 3 for confirmation. The random secret will no longer be returned to the identity verification unit for use.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method of providing out of band authentication over mobile network, comprising steps of:
a) generating a pair of a public key and a private key by an identity verification unit in a mobile communication device and creating a Personal Identification Number (PIN) code by the identity verification unit;
b) sending the public key with an identity number to a first server through a first mobile communication channel by the mobile communication device;
c) receiving a message containing a random secret and an operational information from a second server via the first server through a second mobile communication channel by the mobile communication device, wherein the message is encrypted with the public key provided by the first server provided that the identity number is sent along with the message by the second server;
d) decrypting the message with the private key by the identity verification unit;
e) displaying the operational information by the mobile communication device for requesting a verification code for the operational information from a user;
f) receiving the verification code by the mobile communication device;
g) verifying if the verification code is the same as the PIN code and signing the random secret with the private key by the identity verification unit when verified; and
h) sending the signed random secret to the first server by the mobile communication device through the first mobile communication channel.

2. The method according to claim 1, wherein the identity verification unit is a Subscriber Identity Module (SIM) card in the mobile communication device, a thin film SIM attached to a SIM card in the mobile communication device, or a Central Processing Unit (CPU) of the mobile communication device running an embedded-SIM (eSIM) or a program.

3. The method according to claim 1, wherein the first mobile communication channel is an Over-The-Air (OTA) technology communication channel, implemented by Bearer Independent Protocol (BIP).

4. The method according to claim 1, wherein the second mobile communication channel is an OTA technology communication channel, implemented by Short Message Service-Point to Point (SMS-PP) technology.

5. The method according to claim 1, wherein the first mobile communication channel and the second mobile communication channel are both Open Mobile Alliance (OMA) or Google Carrier Services (GCS) channel when the identity verification unit is a CPU of the mobile communication device running a program.

6. The method according to claim 1, wherein the first mobile communication channel and the second mobile communication channel are accessed by the mobile communication device through a non-wi-fi access point.

7. The method according to claim 1, wherein the random secret is a randomly generated token, a time-based token, a counter-based token, a transaction identifier, or a hashed transaction identifier.

8. The method according to claim 1, wherein the identity number is International Mobile Subscriber Identity (IMSI) attached to a cellular mobile network, Mobile Subscriber ISDN Number (MSISDN) attached to a cellular mobile network or wallet address attached to a blockchain network.

9. The method according to claim 1, wherein the operational information is authenticating information or transactional information.

10. A computer program product, when loaded into an identity verification unit of a mobile communication device and executed, performing the method as described in claim 1.

11. A method of providing out of band authentication over mobile network, comprising the steps of:
a) generating a pair of a public key and a private key by an identity verification unit in a mobile communication device and sending the public key with an identity number to a first server through a first mobile communication channel by the mobile communication device;
b) receiving a message containing a random secret and an operational information from a second server via the first server through a second mobile communication channel by the mobile communication device, wherein the message is encrypted with the public key provided by the first server provided that the identity number is sent along with the message by the second server;
c) decrypting the message with the private key by the identity verification unit; and
d) displaying the operational information and the random secret by the mobile communication device for use by a user.

12. The method according to claim 11, wherein the identity verification unit is a SIM card in the mobile communication device, a thin film SIM attached to a SIM card in the mobile communication device, or a CPU of the mobile communication device running an eSIM or a program.

13. The method according to claim 11, wherein the first mobile communication channel is an OTA technology communication channel, implemented by BIP.

14. The method according to claim 11, wherein the second mobile communication channel is an OTA technology communication channel, implemented by SMS-PP technology.

15. The method according to claim 11, wherein the first mobile communication channel and the second mobile communication channel are both OMA or GCS channel when the identity verification unit is a CPU of the mobile communication device running a program.

16. The method according to claim 11, wherein the first mobile communication channel and the second mobile communication channel are accessed by the mobile communication device through a non-wi-fi access point.

17. The method according to claim 11, wherein the random secret is a randomly generated token, a time-based token, a counter-based token, a transaction identifier, or a hashed transaction identifier.

18. The method according to claim 11, wherein the identity number is IMSI attached to a cellular mobile network, MSISDN attached to a cellular mobile network or wallet address attached to a blockchain network.

19. The method according to claim 11, wherein the operational information is authenticating information or transactional information.

20. A computer program product, when loaded into an identity verification unit of a mobile communication device and executed, performing the method as described in claim 11.
